(19) United States
(12) Patent Application Publication
(10) Pub. No.: US 2021/0024006 A1
(43) Pub. Date: Jan. 28, 2021

(54) MOTORCYCLE ACCESSORY MOUNT

(71) Applicant: Ciro, LLC, Hudson, WI (US)

(72) Inventor: Christopher Lindloff, New Richmond, WI (US)

(21) Appl. No.: 16/520,734

(22) Filed: Jul. 24, 2019

(51) Int. Cl. B60R 11/02

(52) U.S. Cl. CPC B60R 11/02

(57) ABSTRACT

A first clamp portion connectable to a second clamp portion of a clam shell clamp, that attaches hand controls on the left handlebar of a motorcycle, includes a base on an upper end of the clamp portion that is configured for attaching an accessory mount to the base of the clamp portion.

### BACKGROUND

This disclosure relates to accessory mounts for mounting accessories, such as a drink holder, cell phone or GPS device, on a motorcycle for easy access to the accessories by the motorcycle operator.

### BRIEF DESCRIPTION OF THE DRAWINGS

FIG. 1 is a front perspective view of a first half of a clam shell clamp for hand controls on the left handlebar of a Honda Gold Wing DCT model motorcycle with an integral accessory mount base for attaching an accessory mount.

FIG. 2 is a rear perspective view of the clamp of FIG. 1.

FIG. 3 is side elevational view of the clamp of FIG. 1.

FIG. 4 is a front elevational view of the clamp of FIG. 1.

### DETAILED DESCRIPTION

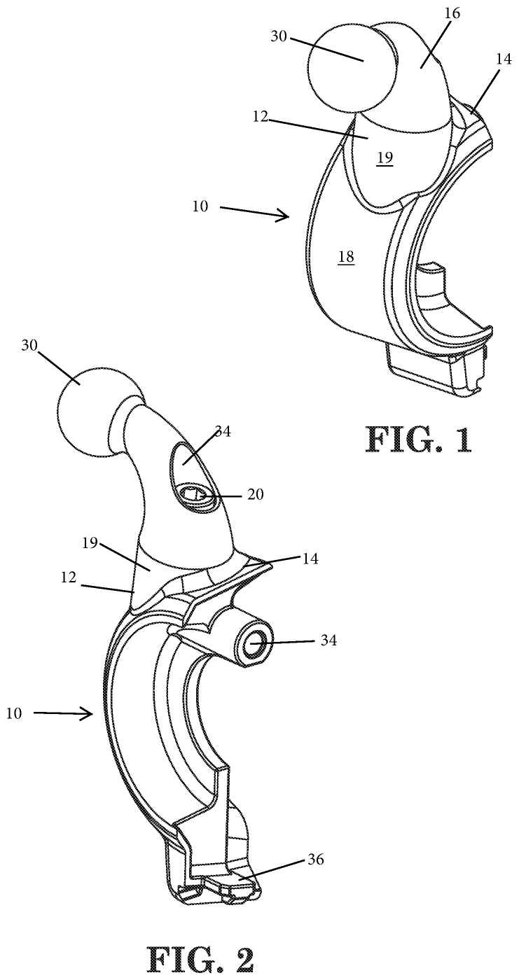

The hand controls for some models of the Honda Goldwing DCT motorcycle are secured to the left handlebar with a clam shell clamp having first and second clamp portions connected together by a single threaded connector, where the first clamp portion is on a rear facing portion of the handlebar and the second clamp portion is on a front facing portion of the handlebar. FIG. 1 is a front perspective view of a first clamp portion 10 to replace the stock first clamp portion of a conventional clam shell clamp for the hand controls on the left handlebar of a Honda Gold Wing DCT model motorcycle. Clamp portion 10 includes an integral base 12 on a top end 14 of the clamp portion 10, for connecting an accessory mount 16, such as a ball mount. In one embodiment, base 12 comprises a protrusion from the outer surface 18 of clamp portion 10 at the top end 14 of the clamp portion 10. In one embodiment, the protrusion comprises a generally cylindrical outer surface 19. As shown in FIG. 2, in one embodiment, base 12 includes a generally round planar top surface and an internally threaded bore generally coaxial with the base outer surface 19 and exposed at the top surface for connecting the accessory mount 16 with a threaded connector 20.

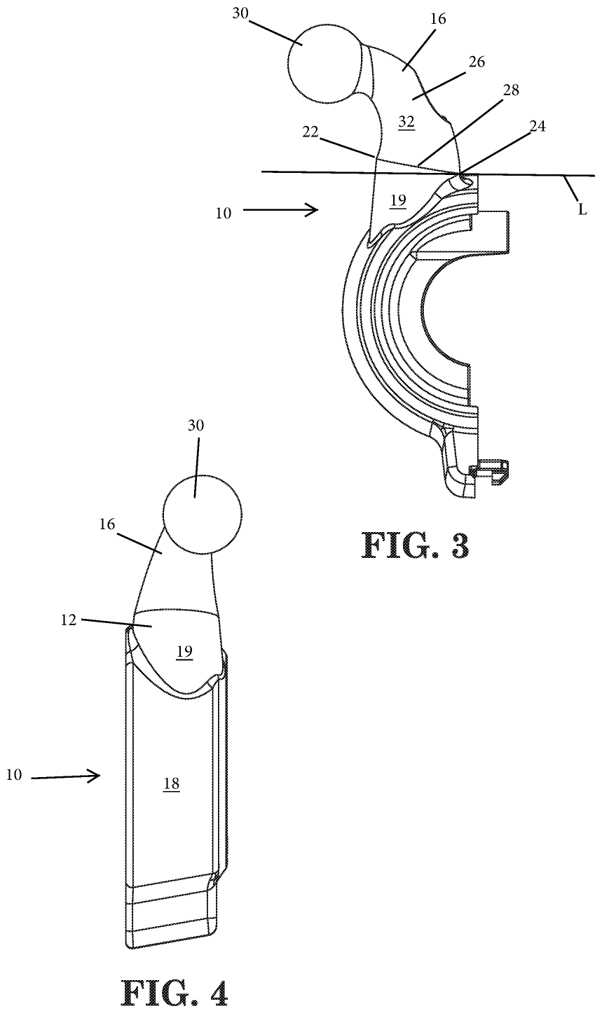

FIG. 3 is a side elevational view of clamp portion 10 as oriented when attached to the second clamp portion on the motorcycle handlebar. As shown in FIG. 3, in one embodiment, the top surface is formed at an angle with a first side 22 of the base top surface being higher than a second side 24 of the base top surface relative to an imaginary horizontal line L representative of a plane that is generally parallel to a level ground surface. Accessor mount 16 can comprises an arm 26 having a first end 28 mateable with the top surface of the base 12 and a second end 30 comprising a spherical ball mount. In one embodiment the first end 28 and the top surface of base 12 can have splined patterns, or any other surface patterns that prevent rotation of arm 26 relative to base 12 when arm 26 is connected to base 12 by the threaded connector 20. In one embodiment, arm 26 can be configured to be non-linear, e.g., curved, such that second end 30 is offset from first end 28. Arm 26 includes an outer surface 32 with a bore 34 through arm 26 that is generally transverse to first end 28, for receiving the threaded connector 20. Arm 26 is can be rotated about the base top surface to any desired location, with the angled top surface allowing the second end 30 of the arm 26 to be adjusted relative to base 12 to a desired location.

Clamp portion 10 is formed from die cast aluminum and includes a conventional threaded connector receptacle 34 and a connector tab 36 and connects to a second clamp portion of a conventional clam shell clamp for the left handlebar hand controls in the same manner as the stock first clamp portion. When clamp portion 10 replaces the stock first clamp portion, the base 12 and accessory mount 16 incorporated into clamp portion 10 provide a convenient location on the motorcycle handlebar for mounting an accessory for a motorcycle operator.

Although the motorcycle accessory mount has been described with reference to preferred embodiments, workers skilled in the art will recognize that changes can be made in form and detail without departing from the spirit and scope of the disclosed mounting structures. For example, the ball associated with the disclosed mount can be replaced with an alternate coupler, or an accessory can be directly coupled to the second end portion of the cylindrical body. Applicant intends that the examples described above do not limit the scope of application's invention, which is defined by the claims below. Applicant's descriptions are not intended to redefine the terms set forth in the claims unless applicant has expressly stated that a term means something different than the plain import of the terms.

1. A first clamp portion, connectable to a second clamp portion of a clam shell clamp that connects hand controls on a motorcycle handlebar, the first clamp portion comprising:
a first end and a second end opposite the first end, the first and second ends configured to mate with corresponding connection sites on the second clamp portion;
a base on an outer surface of the first clamp portion, between the first and second ends, the base having a top surface and configured with an internally threaded bore exposed at the top surface; and
a mounting arm having a first end mateable with the top surface of the base, and a second end opposite the first end, the second end configured to mount an accessory, the mounting arm including a bore through a portion of the arm and exposed at the first end, the bore of the mounting arm receiving a threaded connector to connect the mounting arm to the internally threaded bore of the base.

2. The first clamp portion of claim 1, wherein the top surface is a planar surface formed at an angle relative to a level ground surface when the first clamp portion is connected to the second clamp portion.

3. The first clamp portion of claim 1, wherein mounting arm is non-linear, the second end of the arm being offset from the first end of the arm.

4. The first clamp portion of claim 1, wherein the second end of the mounting arm comprises a ball mount.
